(19) United States
(12) Patent Application Publication
(10) Pub. No.: US 2023/0009749 A1
(43) Pub. Date: Jan. 12, 2023

(54) SYSTEMS AND METHODS FOR CHARGING AN ELECTRIC VEHICLE BASED ON INFERRED DWELL TIME

(71) Applicant: Volta Charging, LLC, San Francisco, CA (US)

(72) Inventors: Jeffrey Kinsey, San Francisco, CA (US); Michael Clement, San Francisco, CA (US); Terril Jamon Douglas, San Francisco, CA (US); Ramsey Meyer, San Francisco, CA (US)

(21) Appl. No.: 17/857,792

(22) Filed: Jul. 5, 2022

Related U.S. Application Data
(60) Provisional application No. 63/218,770, filed on Jul. 6, 2021.

(51) Int. Cl. B60L 53/66; B60L 53/62; B60L 58/12; B60L 53/65; G06Q 30/04; G07F 15/00

(52) U.S. Cl. CPC B60L 53/665; B60L 53/62; B60L 58/12; B60L 53/65; G06Q 30/04; G07F 15/005; G06Q 2240/00

(57) ABSTRACT

Systems and methods are provided herein for charging an electric vehicle based on the inferred dwell time of a user of the electric vehicle. This may be accomplished by an electric vehicle charging station (EVCS) receiving a request from a user to charge an electric vehicle. The EVCS can use the request to identify a profile associated with the user, wherein the profile comprises user information related to the user. The EVCS then estimates a dwell time for the user using the user information. The EVCS can use the dwell time to estimate a total charge time for the electric vehicle. The EVCS then charges the electric vehicle based on the estimated charge time.

### BACKGROUND

The present disclosure relates to computer-implemented techniques for charging electric vehicles, and in particular to techniques for allocating resources to electric vehicles based on information corresponding to an inferred dwell time.

### SUMMARY

As more consumers transition to electric vehicles, there is an increasing demand for electric vehicle charging stations (EVCSs). These EVCSs usually supply electric energy, either using cables or wirelessly, to the batteries of electric vehicles. For example, a user can connect their electric vehicle via cables of an EVCS and the EVCS supplies electrical current to the user's electric vehicle. The cables and control systems of the EVCSs can be housed in kiosks in locations to allow a driver of an electric vehicle to park the electric vehicle close to the EVCS and begin the charging process. These kiosks may be placed in areas of convenience, such as in parking lots at shopping centers, in front of commercial buildings, or in other public places. These kiosks often comprise a display that can be used to provide media items to the user to enhance the user's charging experience. Consequently, passers-by, in addition to users of the EVCS, may notice media items displayed by the EVCS. Traditionally, EVCSs provide the same services (e.g., charging rate, charging cost, user experience, etc.) to each electric vehicle that is connected to the EVCSs without considering additional factors (e.g., inferred dwell time, electrical grid load, vehicle information, etc.), which results in inefficient electric vehicle charging.

For example, charging an electric vehicle's battery too quickly can damage the battery, reducing the battery's performance capacity and shortening the battery's life cycle. Slowing the charging rate of a battery is beneficial as it can result in prolonged battery life and more efficient battery performance over the course of the battery's life. Different electric vehicles also have different specifications, battery sizes, battery types, etc., which can affect the optimal charging rate for the batteries of the different electric vehicles. For example, an electric vehicle with a smaller battery may not require charging at the same rate as an electric vehicle with a larger battery. Providing the same charging rate to all electric vehicles regardless of the inferred dwell time or the electric vehicle's requirements results in inefficient charging and unnecessary wear on the electric vehicle's battery.

In another example, during “peak” periods (times when the electrical grid's electric supply is more scarce), electric companies will charge more for EVCSs to charge an electric vehicle. EVCSs using the same charging rate and charging price regardless of the time of day or the inferred dwell time results in increased costs to the EVCSs and increased load on the electrical grid.

In another example, a first media item (e.g., coffee sale) may be more desirable to a user than a second media item (e.g., movie ticket sale) due to the user's dwell time. For example, if a user plans to charge their electric vehicle at the EVCS for two hours, the user may be more interested in learning about the movie ticket sale, while a user planning to charge their electric vehicle for ten minutes may be more interested in learning about the coffee sale. EVCSs providing the same media item on the EVCSs' display regardless of an inferred dwell time results in suboptimal user experiences.

Various systems and methods described herein address these problems by providing a method for charging an electric vehicle based on the inferred dwell time of a user of the electric vehicle. The inferred dwell time relates to the estimated amount of time that a user will be within a first vicinity, which relates to the amount of time that the user's electric vehicle will be charging at the EVCS. As described herein, one methodology to infer a dwell time related to a user of an electric vehicle is for an EVCS to use user information (e.g., user location, user calendars, user purchases, user patterns, etc.). To infer a dwell time using user information, the EVCS first determines a user associated with an electric vehicle. The EVCS may identify the user when the user requests to charge their electric vehicle. For example, the user may have to present some credentials (e.g., password, pin, biometrics, device, item, etc.) to request the EVCS to charge their electric vehicle. The EVCS can use the credentials to identify a user profile associated with the user. The EVCS can then access a database comprising entries that link user profiles with user information. The EVCS can then use the user information to determine an estimated charge time for the electric vehicle. For example, a user may request the EVCS to start charging their electric vehicle at 1:00 pm, and the EVCS may retrieve a first piece of user information indicating that the user purchased a movie ticket for a movie ending at 3:00 pm. The EVCS can use the user information to determine that the estimated charge time will be approximately two hours. The EVCS can then determine a charging rate based on the estimated charge time. For example, a slower charging rate may be used for longer estimated charge times (e.g., two hours), and a faster charging rate may be used for shorter estimated charge times (e.g., fifteen minutes). The charging rate may be selected to optimize maximum charging while minimizing unnecessarily fast charging rates, resulting in a prolonged lifespan of the vehicle's battery. In some embodiments, the optimized charging rates offered by the EVCS also result in a higher resale price for the electric vehicle. For example, a first electric vehicle using the optimized charging rates can have a higher value than a second electric vehicle that does not use the optimized charging rates, because the first electric vehicle's battery is in better condition than the second electric vehicle's battery.

The EVCS can use characteristics of an electric vehicle to determine a user associated with an electric vehicle. To use characteristics of an electric vehicle, an EVCS must first be able to accurately identify characteristics corresponding to the electric vehicle. As described herein, one methodology to identify characteristics about an electric vehicle is for an EVCS to use one or more sensors to capture information about the electric vehicle. For example, these sensors may be image (e.g., optical) sensors (e.g., one or more cameras), ultrasound sensors, depth sensors, Infrared (IR) cameras, Red Green Blue (RGB) cameras, Passive IR (PIR) cameras, thermal IR, proximity sensors, radar, tension sensors, near field communication (NFC) sensors, and/or any combination thereof. In some embodiments, EVCSs support ISO 15118, which allows a user to plug their electric vehicle into an EVCS and begin charging without inputting any additional information. ISO 15118 is a communication interface, which, among other things, can identify the make and model of an electric vehicle to an EVCS. After the one or more sensors captures information about the electric vehicle, the EVCS can use this information to determine the electric vehicle's characteristics (e.g., model, make, license plate, VIN number, tire pressure, specifications, condition, etc.). The EVCS can then use the electric vehicle's characteristics to determine a user associated with the electric vehicle. For example, the EVCS can access a database comprising entries that link electric vehicle's characteristics to a user and/or a user profile. Accordingly, an EVCS can use a first electric vehicle characteristic (e.g., license plate) to determine a user associated with the electric vehicle.

The EVCS can also use characteristics of an electric vehicle in conjunction with user information to determine an inferred dwell time. For example, a user may request the EVCS to start charging their electric vehicle, and the EVCS may retrieve a first piece of user information indicating that the user has no calendar events scheduled for the rest of the day. The EVCS may determine an electric vehicle characteristic that the electric vehicle's battery is 5% charged. The EVCS can use the characteristic of an electric vehicle (battery being 5% charged) in conjunction with user information (no calendar events) to determine an inferred dwell time (e.g., two hours). The EVCS may make this determination because users accept that they will spend more time at a location comprising a charging station when their electric vehicle has a low battery percentage because it takes more time to charge an electric vehicle with a low battery percentage than one with a high battery percentage. The EVCS may also display a first media (e.g., movie ticket sale) for the user because the first media corresponds to an activity with a time frame similar to the inferred dwell time (e.g., two hours). In another example, a second user may request the EVCS to start charging their electric vehicle and the EVCS may retrieve a second piece of user information indicating that the second user also has no calendar events scheduled for the rest of the day. The EVCS may determine an electric vehicle characteristic relating to the second electric vehicle that the second electric vehicle's battery is 90% charged. The EVCS can use the characteristics of the second electric vehicle (battery being 90% charged) in conjunction with user information (no calendar events) to determine an inferred dwell time (e.g., fifteen minutes). The EVCS may make this determination because users assume that they will not spend as much time at a location comprising a charging station when their electric vehicle has a higher battery percentage because it takes less time to charge an electric vehicle with a higher battery percentage. The EVCS may also display a second media (e.g., coffee sale) for the second user because the second media corresponds to an activity with a time frame similar to the inferred dwell time (e.g., fifteen minutes).

The EVCS can also use characteristics of an electric vehicle in conjunction with user information to determine charging rates. For example, a user may request the EVCS to start charging their electric vehicle at 1:00 pm, and the EVCS may retrieve a first piece of user information indicating that a device associated with the user (e.g., smartphone, tablet, etc.) crossed a geofence at 1:05 pm. The EVCS can use the user information to determine an estimated charge time (e.g., fifteen minutes) based on the amount of time the user normally spends in the location related to the geofence. For example, the user may spend different amounts of time in different locations (e.g., average of ten minutes in coffee shops, average of two hours in restaurants, etc.). The EVCS may determine an electric vehicle characteristic that the electric vehicle's battery is 5% charged. The EVCS can determine a first charging rate using the estimated charge time (e.g., fifteen minutes) and the electric vehicle characteristic that the electric vehicle's battery is 5% charged. The first charging rate may be faster than a second charging rate because the electric vehicle's battery requires significant charging in a short amount of time. In another example, the EVCS determines to use the second charging rate to charge a second electric vehicle. The EVCS may make this determination based on a second estimated charge time (e.g., two hours) and a second electric vehicle characteristic (e.g., a second electric vehicle's battery is 5% charged). Accordingly, the second electric vehicle is not subjected to unnecessarily fast charging rates (e.g., first charging rate), resulting in a prolonged lifespan of the vehicle's battery.

The EVCS can also use location information (e.g., local patterns, electrical grid information, site information, etc.) in conjunction with user information to determine an inferred dwell time. For example, a user may request the EVCS to start charging their electric vehicle and the EVCS may retrieve a first piece of user information indicating that the user purchased an item for pickup from a location (e.g., restaurant) within a threshold distance (e.g., one mile) from the EVCS. The EVCS may determine a first local pattern, that users who purchased an item for pickup from the location wait an average time within a time frame (e.g., fifteen minutes). The first local pattern may be received from a database comprising entries linking user dwell times to locations. The EVCS can use the location information (that users who purchased an item for pick up from the location wait an average of fifteen minutes) in conjunction with user information (the user purchased the item for pickup from the location) to determine an inferred dwell time (e.g., fifteen minutes).

The EVCS can also use location information in conjunction with user information to determine charging rates. For example, a user may request the EVCS to start charging their electric vehicle at 1:00 pm, and the EVCS may retrieve a first piece of user information indicating that the user purchased a movie ticket for a movie ending at 3:00 pm. The EVCS can use the user information to determine an estimated charge time (e.g., two hours). The EVCS can retrieve location information (e.g., peak electrical time spans from 11:30 am-2:30 pm). The EVCS can determine a first charging rate using the estimated charge time (e.g., two hours) and the location information (e.g., peak electrical time spans from 11:30 am-2:30 pm). The first charging rate may be different from a second charging rate because the EVCS determines that the first charging rate needs to decrease load on the electrical grid during the peak time and decrease electrical costs to the EVCS. The first charging rate may provide little to no charge for the first hour and a half (1:00 pm-2:30 pm) of the two-hour estimated charge time when the electrical grid load is at a peak. The first charging rate may then provide a more rapid charge for the last half hour (2:30 pm-3:00 pm) of the first estimated charge time during a non-peak electrical time. The first charging rate may result in cheaper charging prices for the EVCS and less load on the electrical grid. In another example, site information is used in conjunction with user information to determine charging rates. Site information relates to the parameters of the EVCS's location. For example, newer locations (malls, shopping centers, etc.) may have more advanced electrical architecture allowing for higher output of electric energy compared to locations with older electrical architecture. Accordingly, sites with higher output may allow for faster charging rates compared to sites with lower outputs.

The EVCS may leverage machine learning to identify inferred dwell time, user information, electric vehicle characteristics, location information, and similar such information. For example, U.S. Application No. 63/177,787, the entire disclosure of which is herein incorporated by reference, describes some examples of using machine learning to identify, user information, electric vehicle characteristics, and similar such information. The EVCS may use any combination of user information, electric vehicle characteristics, location information, and similar such information to determine the inferred dwell time, estimated charge time, and/or the charging rate.

### BRIEF DESCRIPTION OF THE DRAWINGS

The below and other objects and advantages of the disclosure will be apparent upon consideration of the following detailed description, taken in conjunction with the accompanying drawings, in which like reference characters refer to like parts throughout, and in which:

FIG. 1 shows an illustrative diagram of a system for charging an electric vehicle based on an inferred dwell time of a user of the electric vehicle, in accordance with some embodiments of the disclosure;

FIGS. 2A-2F show block diagrams of an illustrative process for determining a charging rate for an electric vehicle based on the inferred dwell time of a user of the electric vehicle, in accordance with some embodiments of the disclosure;

FIGS. 3A and 3B illustrate an EVCS used for charging an electric vehicle based on the inferred dwell time of a user of the electric vehicle, in accordance with some embodiments of the disclosure;

FIG. 4 shows an illustrative block diagram of an EVCS system, in accordance with some embodiments of the disclosure;

FIG. 5 shows an illustrative block diagram of a user equipment device system, in accordance with some embodiments of the disclosure;

FIG. 6 shows an illustrative block diagram of a server system, in accordance with some embodiments of the disclosure;

FIG. 7 is an illustrative flowchart of a process for charging an electric vehicle based on the inferred dwell time of a user of the electric vehicle, in accordance with some embodiments of the disclosure;

FIG. 8 is another illustrative flowchart of a process for charging an electric vehicle based on the inferred dwell time of a user of the electric vehicle, in accordance with some embodiments of the disclosure; and

FIG. 9 is another illustrative flowchart of a process for charging an electric vehicle based on the inferred dwell time of a user of the electric vehicle, in accordance with some embodiments of the disclosure.

### DETAILED DESCRIPTION

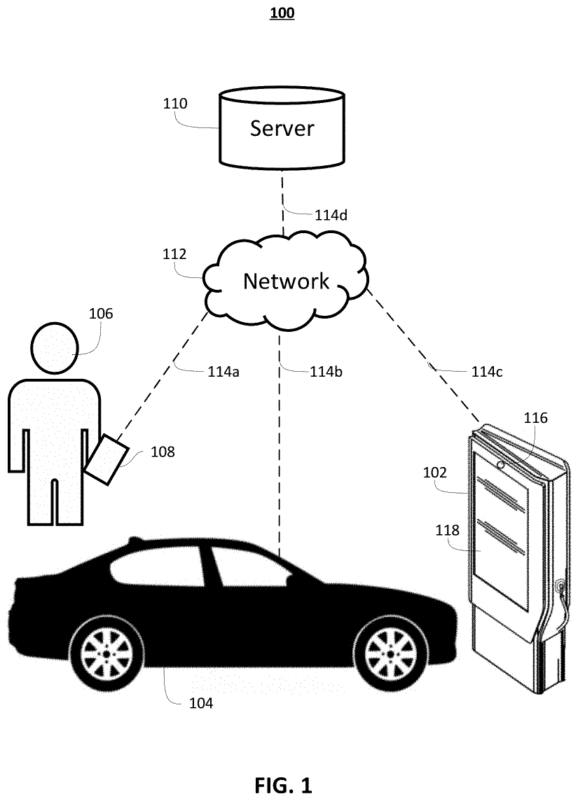

FIG. 1 shows an illustrative diagram of a system 100 for charging an electric vehicle 104 based on an inferred dwell time of a user 106 of the electric vehicle, in accordance with some embodiments of the disclosure. In some embodiments, the EVCS 102 provides an electric charge to the electric vehicle 104 via a wired connection, such as a charging cable, or a wireless connection (e.g., wireless charging). The EVCS 102 may be in communication with the electric vehicle 104 and/or a user device 108 belonging to a user 106 (e.g., a driver, passenger, owner, renter, or other operator of the electric vehicle 104) that is associated with the electric vehicle 104. In some embodiments, the EVCS 102 communicates with one or more devices or computer systems, such as user device 108 or server 110, respectively, via a network 112.

In the system 100, there can be more than one EVCS 102, electric vehicle 104, user, 106, user device 108, server 110, and network 112, but only one of each is shown in FIG. 1 to avoid overcomplicating the drawing. In addition, a user 106 may utilize more than one type of user device 108 and more than one of each type of user device 108. In some embodiments, there may be paths 114a-d between user devices, EVCSs, servers, and/or electric vehicles, so that the items may communicate directly with each other via communication paths, as well as other short-range point-to-point communication paths, such as USB cables, IEEE 1394 cables, wireless paths (e.g., Bluetooth, infrared, IEEE 802-11x, etc.), or other short-range communication via wired or wireless paths. In an embodiment, the devices may also communicate with each other directly through an indirect path via a communications network. The communications network may be one or more networks including the Internet, a mobile phone network, mobile voice or data network (e.g., a 4G, 5G, or LTE network), cable network, public switched telephone network, or other types of communications network or combinations of communications networks. In some embodiments, a communication network path comprises one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, a communication network path can be a wireless path. Communications with the devices may be provided by one or more communication paths but is shown as a single path in FIG. 1 to avoid overcomplicating the drawing.

In some embodiments, the EVCS 102 infers a dwell time related to the user 106 of the electric vehicle 104 using user information (e.g., user location, user calendars, user purchases, user patterns, etc.). In some embodiments, to infer a dwell time using user information the EVCS 102 determines a user 106 associated with the electric vehicle 104. In some embodiments, the user 106 may have to present some credentials (e.g., password, pin, biometrics, device, item, etc.) when requesting the EVCS 102 to charge their electric vehicle 104. For example, the user 106 may enter a password on the display 118 of the EVCS 102. In another example, the user 106 may enter a biometric password (e.g., fingerprint) on the user device 108, which is then communicated to the EVCS 102 and/or the server 110 via the network 112. In some embodiments, the credentials may be automatically inputted. For example, the user device 108 may automatically transmit user credentials to the EVCS 102 when the user device 108 is within a threshold distance of the EVCS 102. In some embodiments, the EVCS 102 uses characteristics of the electric vehicle 104 as credentials. For example, the EVCS 102 may automatically obtain characteristics of the electric vehicle 104 using ISO 15118 when the user 106 plugs in their electric vehicle 104. In some embodiments, the EVCS 102 uses the credentials to identify a user profile associated with the user 106. For example, the EVCS 102 may access a database (e.g., located on server 110) that associates credentials with a user profile. In some embodiments, the user profile stores information about the user 106. For example, the user profile may store user information related to the user 106, vehicle information of the electric vehicle 104 related to the user 106, and/or similar such information.

In some embodiments, the EVCS 102 uses user information obtained from the user profile to determine an estimated charge time for the electric vehicle 104. In some embodiments, EVCS 102 retrieves a first piece of user information (e.g., the user 106 purchasing a movie ticket for a two-hour movie) indicating that the user 106 will be within a first vicinity (e.g., near the EVCS 102) for an estimated amount of time. In some embodiments, the EVCS 102 uses the estimated dwell time that a user will be within a first vicinity to determine an estimated charge time for the electric vehicle 104. In some embodiments, the EVCS 102 determines a charging rate for the electric vehicle 104 based on the estimated charge time. For example, a slower charging rate may be used for longer estimated charge times (e.g., two hours) and a faster charging rate may be used for shorter estimated charge times (e.g., fifteen minutes). Accordingly, an electric vehicle is not subjected to unnecessarily fast charging rates, resulting in a prolonged lifespan of the vehicle's battery.

In some embodiments, the EVCS 102 uses characteristics of the electric vehicle 104 to determine the user 106 associated with the electric vehicle 104. In some embodiments, the EVCS 102 uses one or more sensors to capture information about the electric vehicle 104. For example, these sensors may be image (e.g., optical) sensors (e.g., one or more cameras 116), ultrasound sensors, depth sensors, IR cameras, RGB cameras, PIR camera, thermal IR, proximity sensors, radar, tension sensors, NFC sensors, and/or any combination thereof. In some embodiments, one or more cameras 116 are configured to capture one or more images of an area proximal to the EVCS 102. For example, a camera may be configured to obtain a video or capture images of an area corresponding to a parking spot associated with the EVCS 102, a parking spot next to the parking spot of the EVCS 102, and/or walking paths (e.g., sidewalks) next to the EVCS 102. In some embodiments, the camera 116 may be a wide-angle camera or a 3600 camera that is configured to obtain a video or capture images of a large area proximal to the EVCS 102. In some embodiments, the camera 116 may be positioned at different locations on the EVCS 102 than what is shown. In some embodiments, the camera 116 works in conjunction with other sensors. In some embodiments, the one or more sensors (e.g., camera 116) can detect external objects within a region (area) proximal to the EVCS 102. In some embodiments, the one or more sensors are configured to determine a state of the area proximal to the EVCS 102. In some embodiments, the state may correspond to detecting external objects, detecting the lack of external objects, etc. In some embodiments, the external objects may be living or nonliving, such as people, kids, animals, vehicles, shopping carts, toys, etc.

In some embodiments, after the one or more sensors captures information, the EVCS 102 can use this information to determine the electric vehicle's 104 characteristics (e.g., model, make, specifications, condition, etc.). In some embodiments, using the data collected from the one or more sensors, the EVCS 102 can identify electric vehicle characteristics by leveraging machine learning. The EVCS 102 can use the determined electric vehicle characteristics to determine the user 106 associated with the electric vehicle 104. For example, the EVCS 102 can receive an image of the license plate (e.g., information captured by the one or more sensors) of the electric vehicle 104 from the camera 116. In some embodiments, the EVCS 102 reads the license plate (e.g., using optical character recognition) and uses the license plate information (e.g., electric vehicle characteristic) to determine the user 106 associated with the electric vehicle 104. In some embodiments, the EVCS 102 uses a database to look up user information and/or additional vehicle characteristics of the electric vehicle 104 using the license plate information. For example, the database may comprise public records (e.g., public registration information linking license plates to vehicle characteristics), collected information (e.g., entries linking license plates to vehicle characteristics based on data inputted by a user), historic information (entries linking license plates to vehicle characteristics based on the EVCS 102 identifying vehicle characteristics related to one or more license plates in the past), and/or similar such information.

In some embodiments, the EVCS 102 uses information captured from the one or more sensors to determine vehicle characteristics of the electric vehicle 104 and/or to determine the user 106 associated with the electric vehicle 104. In some embodiments, upon connection, the EVCS 102 receives a media access control (MAC) address from the electric vehicle 104 and the EVCS 102 uses the MAC address to determine vehicle characteristics of the electric vehicle 104 and/or to determine the user 106 associated with the electric vehicle 104. The EVCS 102 can use a database to match the received MAC address or portions of the received MAC address to entries in the database to determine vehicle characteristics of the electric vehicle 104. For example, certain vehicle manufacturers keep portions of their produced electric vehicle's MAC addresses consistent. Accordingly, if the EVCS 102 determines that a portion of the MAC address received from the electric vehicle 104 corresponds to an electric vehicle manufacturer, the EVCS 102 can determine vehicle characteristics of the electric vehicle 104. The EVCS 102 can also use a database to match the received MAC address or portions of the received MAC address to entries in the database to determine the user 106 associated with the electric vehicle 104. For example, the electric vehicle's MAC address may correspond to a user profile corresponding to the user 106 associated with the electric vehicle 104.

In some embodiments, the EVCS 102 uses user information to determine vehicle characteristics of the electric vehicle 104. For example, the user 106 may input vehicle characteristics into a profile that is accessible by the EVCS 102. In some embodiments, when the EVCS 102 determines that the user 106 is charging their electric vehicle 104, the EVCS 102 receives vehicle characteristics associated with the electric vehicle 104 from a profile associated with the user 106.

In some embodiments, the EVCS 102 can use the information captured by the one or more sensors to determine an estimated charge time. For example, the one or more sensors may determine that the electric vehicle's battery is 20% charged. Based on this information, the EVCS 102 can determine an estimated charge time (e.g., one hour). The EVCS 102 may determine the estimated charge time based on accessing a database where battery percentages correspond to estimated charge times. In some embodiments, the estimated charge time can be used in conjunction with and/or derived from information captured by the one or more other sensors. For example, using the camera 116, the EVCS 102 can determine the make and model of the electric vehicle 104, and a battery sensor can determine the battery percentage of the electric vehicle 104. The EVCS 102 can then access a database to determine the estimated charge time when using an optimal charging rate given the make, model, and battery percentage of the electric vehicle 104.

In some embodiments, the EVCS 102 determines an estimated charge time for the electric vehicle 104 and uses the estimated charge time to customize media displayed by the display 118. For example, if the estimated charge time of the electric vehicle 104 is a longer time frame, the EVCS 102 can determine that a first media item (e.g., movie ticket sale) may be more desirable to the user 102 of the electric vehicle 104 because the first media item corresponds to an activity with a longer time frame. If the estimated charge time of the electric vehicle 104 is a shorter time frame, the EVCS 102 can determine that a second media item (e.g., coffee sale) may be more desirable to the user 102 of the electric vehicle 104 because the second media item corresponds to an activity that can be completed more quickly. In some embodiments, the EVCS 102 customizes media to display based on other vehicle characteristics. For example, the EVCS 102 can determine the depth of the tire tread of the electric vehicle 104 using the one or more sensors and customize media items based on the condition of the tire tread. If the EVCS 102 determines that the tire tread is too shallow, EVCS 102 can display media items (e.g., tire tread notification, tire sales, etc.) relating to the tire tread condition.

In some embodiments, the EVCS 102 determines an inferred dwell time for the user 106 and uses the inferred dwell time to customize media displayed by the display 118. For example, if the inferred dwell time is a longer time frame, the EVCS 102 can determine that a first media item (e.g., movie ticket sale) may be more desirable to the user 102 of the electric vehicle 104 because the first media item corresponds to an activity with a longer time frame. If the inferred dwell time is a shorter time or is within a shorter time frame, the EVCS 102 can determine that a second media item (e.g., coffee sale) may be more desirable to the user 102 of the electric vehicle 104 because the second media item corresponds to an activity that can be completed more quickly. In some embodiments, EVCS 102 uses the inferred dwell time to customize media displayed by the display 118 to passers-by. For example, if the inferred dwell time is a longer time frame, the EVCS 102 can determine that the user 106 will not be viewing the display 118 for a majority of the time frame. In some embodiments, the EVCS 102 prioritizes a third media item (e.g., charging price sales), wherein the third media item is selected based on passers-by rather than the user 106.

In some embodiments, the EVCS 102 transmits the inferred dwell time, received user information, vehicle characteristics, and/or similar such information to one or more devices. For example, the EVCS 102 may transfer one or more pieces of collected information to a database that can be used to improve dwell time estimates. In another example, the EVCS 102 may transfer the one or more pieces of collected information to third-party providers. In some embodiments the EVCS 102 also determines the actual dwell time of the user 106. For example, the EVCS 102 may calculate the amount of time it takes for the user 106 to return to the EVCS 102. In some embodiments, the EVCS 102 transmits the actual dwell time of the user 106 to one or more devices.

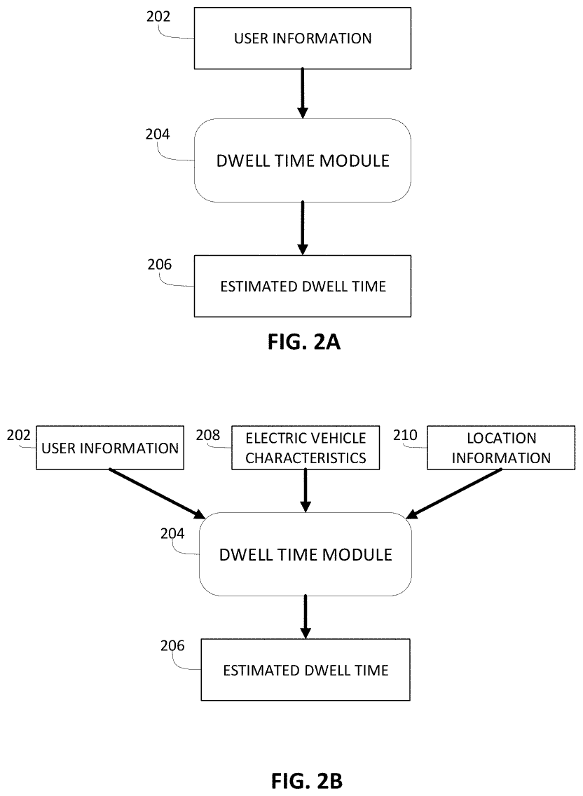

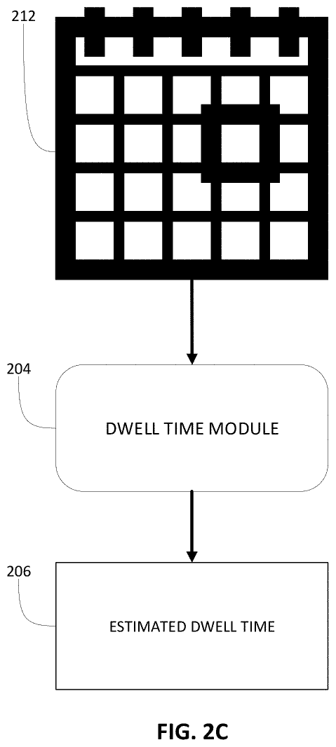

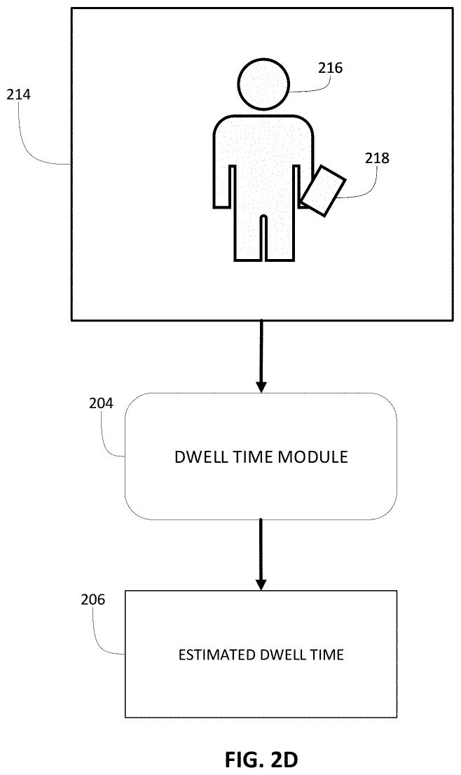

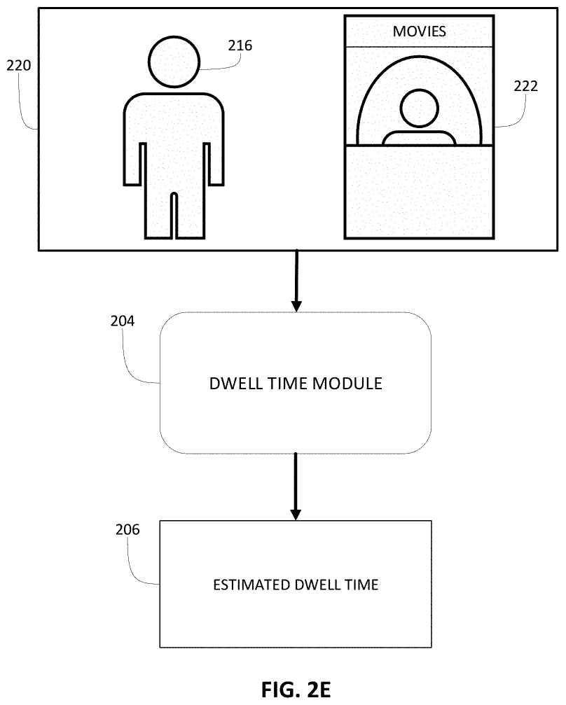

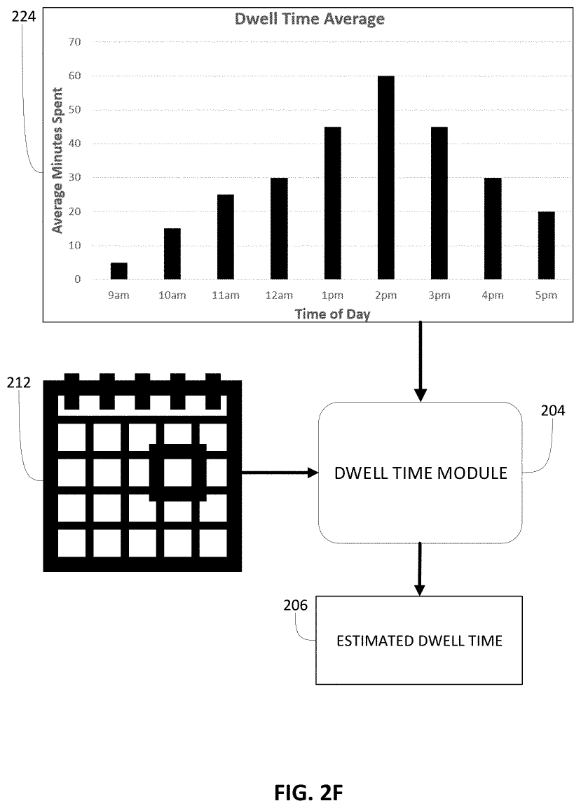

FIGS. 2A-2F show block diagrams of an illustrative process for determining a charging rate for an electric vehicle based on the inferred dwell time of a user of the electric vehicle, in accordance with some embodiments of the disclosure. In some embodiments, FIGS. 2A-2F use the same or similar methods and devices described in FIG. 1.

FIG. 2A shows a dwell time module 204 receiving user information 202 and outputting an estimated dwell time 206. As described herein, the dwell time module 204 may be located in an EVCS (e.g., EVCS 102), a server (e.g., server 110), a user device (e.g., user device 108) or any combination thereof. As described above, the estimated dwell time 206 relates to the estimated amount of time that a user (e.g., user 106) will be within a first vicinity, which relates to the amount of time that the user's electric vehicle (e.g., electric vehicle 104) will be charging at an EVCS (e.g., EVCS 102).

In some embodiments, to determine the estimated dwell time 206, the dwell time module 204 uses user information 202 (e.g., user location, user calendars, user purchases, user patterns, etc.). The dwell time module 204 has a variety of methods of obtaining the user information 202 (e.g., receiving the user information 202 from a database, receiving the user information 202 from a user, receiving the user information 202 from a third-party provider, etc.). The dwell time module 204 can use one piece of user information 202 or a plurality of user information to determine the estimated dwell time 206. In some embodiments, different user information is weighted according to significance. For example, a first piece of user information indicating that the user has an upcoming event may be weighted more highly than a second piece of user information indicating that the user made a purchase two weeks ago. Accordingly, the dwell time module 204 will use the different weights in determining an estimated dwell time 206 of the user. In some embodiments, the dwell time module 204 outputs the estimated dwell time 206 to an EVCS (e.g., EVCS 102), a server (e.g., server 110), a user device (e.g., user device 108) or any combination thereof. In some embodiments, the estimated dwell time is used to determine an estimated charge time and/or a charging rate for an electric vehicle. In some embodiments, the dwell time module 204 uses the estimated dwell time 206 to determine an estimated charge time for an electric vehicle. In some embodiments, the dwell time module 204 uses the estimated dwell time 206 and/or the estimated charge time to determine a charging rate to charge an electric vehicle.

FIG. 2B shows a dwell time module 204 receiving user information 202, electric vehicle characteristics 208, and location information 210 and outputting an estimated dwell time 206. In some embodiments, the dwell time module 204 generates an estimated dwell time 206 in the same or similar way as described above in FIG. 2A. In some embodiments, the dwell time module 204 uses any combination of user information 202, electric vehicle characteristics 208, location information 210, and similar such information to determine the estimated dwell time 206. In some embodiments, the dwell time module 204 receives only the user information 202 and the electric vehicle characteristics 208 and determines the estimated dwell time 206. In some embodiments, the dwell time module 204 receives only the user information 202 and the location information 210 and determines the estimated dwell time 206. The dwell time module 204 can use one or more pieces of user information 202, electric vehicle characteristics 208, and/or location information 210 to determine the estimated dwell time 206. In some embodiments, different information is weighted according to significance. Accordingly, the dwell time module 204 will use the different weights in determining an estimated dwell time 206. In some embodiments, the dwell time module 204 outputs the estimated dwell time 206 to an EVCS (e.g., EVCS 102), a server (e.g., server 110), a user device (e.g., user device 108) or any combination thereof. In some embodiments, the estimated dwell time is used to determine an estimated charge time and/or a charging rate for an electric vehicle. In some embodiments, the dwell time module 204 uses the estimated dwell time 206 to determine an estimated charge time for an electric vehicle. In some embodiments, the dwell time module 204 uses the estimated dwell time 206 and/or the estimated charge time to determine a charging rate to charge an electric vehicle. In some embodiments, the dwell time module 204 uses one or more pieces of information to determine the estimated dwell time and then uses a different one or more pieces of information to determine the estimated charge time and/or charging rate of an electric vehicle. For example, the dwell time module 204 can use the user information 202 to determine the estimated dwell time 206 and can use the estimated dwell time 206 and electric vehicle characteristics 208 to determine the estimated charge time. In some embodiments, the dwell time module 204 uses one or more pieces of information to determine the estimated dwell time and then uses the same one or more pieces of information to determine the estimated charge time and/or charging rate of an electric vehicle. For example, the dwell time module 204 can use the user information 202 and location information 210 to determine the estimated dwell time 206 and can then use the estimated dwell time 206, user information 202, and location information 210 to determine the estimated charge time.

FIG. 2C shows an embodiment of a dwell time module 204 receiving a user's calendar information 212 (user information) and outputting an estimated dwell time 206 for a user. The dwell time module 204 can use the user's calendar information 212 to determine an estimated dwell time 206. For example, the user may request an EVCS to start charging their electric vehicle at 1:00 pm, and the dwell time module 204 may receive a user's calendar information 212 indicating that the user has an event, located within the vicinity of the EVCS, ending at 3:00 pm. The dwell time module 204 can use the user's calendar information 212 to determine that the estimated dwell time 206 is approximately two hours. In some embodiments, the dwell time module 204 can also determine an estimated charge time and/or charging rate for the electric vehicle of the user. For example, a slower charging rate may be used for longer estimated dwell times (e.g., two hours), and a faster charging rate may be used for shorter estimated dwell times (e.g., fifteen minutes). Accordingly, an electric vehicle is not subjected to unnecessarily fast charging rates, resulting in a prolonged lifespan of the vehicle's battery.

FIG. 2D shows an embodiment of a dwell time module 204 receiving a geofence notification (user information) and outputting an estimated dwell time 206 for a user 216. The dwell time module 204 can use the geofence notification to determine an estimated dwell time 206. For example, the user 216 may request an EVCS to start charging their electric vehicle at 1:00 pm and the dwell time module 204 may receive a geofence notification indicating that a device 218 associated with the user 216 crossed a geofence 214 at 1:05 pm. The dwell time module 204 can use the geofence notification to determine an estimated dwell time (e.g., fifteen minutes) based on the amount of time that the user spent in the location related to the geofence 214 in the past. For example, the dwell time module 204 may receive past user behavior patterns indicating that the user 216 spent an average amount of time (e.g., fifteen minutes) in the location related to the geofence 214. In some embodiments, the location related to the geofence 214 may correspond to an estimated dwell time (e.g., coffee shops correspond to fifteen minutes, movie theaters correspond to two hours, etc.). In some embodiments, the dwell time module 204 can also determine an estimated charge time and/or charging rate for the electric vehicle of the user based on the estimated dwell time 206. For example, a slower charging rate may be used for longer estimated dwell times (e.g., two hours), and a faster charging rate may be used for shorter estimated dwell times (e.g., fifteen minutes). Accordingly, an electric vehicle is not subjected to unnecessarily fast charging rates, resulting in a prolonged lifespan of the vehicle's battery.

FIG. 2E shows an embodiment of a dwell time module 204 receiving a purchase notification 220 (user information) and outputting an estimated dwell time 206 for a user 216. The dwell time module 204 can use the purchase notification 220 to determine an estimated dwell time 206. For example, the user 216 may request the EVCS to start charging their electric vehicle at 1:00 pm, and the dwell time module 204 may retrieve a purchase notification indicating that the user 216 purchased a movie ticket 222 for a movie ending at 3:00 pm. The dwell time module 204 can use the purchase notification 220 to determine that the estimated dwell time 206 will be approximately two hours. In some embodiments, the dwell time module 204 can also determine an estimated charge time and/or charging rate for the electric vehicle of the user based on the estimated dwell time 206. For example, a slower charging rate may be used for longer estimated charge times (e.g., two hours), and a faster charging rate may be used for shorter estimated charge times (e.g., fifteen minutes). Accordingly, an electric vehicle is not subjected to unnecessarily fast charging rates, resulting in a prolonged lifespan of the vehicle's battery.

FIG. 2F shows an embodiment of a dwell time module 204 receiving a user's calendar information 212 (user information) and location trends 224 (location information) and outputting an estimated dwell time 206 for a user. In some embodiments, the dwell time module 204 can use the user's calendar information 212 and location trends 224 to determine an estimated dwell time 206. For example, the user may request an EVCS to start charging their electric vehicle at 1:00 pm and the dwell time module 204 may receive a user's calendar information 212 indicating that the user has an event (e.g., getting a haircut) occurring at a location. In some embodiments, the user's calendar information 212 is ambiguous on the end time for the event. The dwell time module 204 may also receive location trends 224 comprising the dwelling trends of the location. In some embodiments, the dwelling trends can relate to amount of time users normally spend in the location. For example, users may spend different amounts of time in different locations (e.g., average of ten minutes in coffee shops, average of two hours in restaurants, etc.). In some embodiments, the dwell trends indicate that the average dwell time changes depending on other factors (e.g., time of day, day of the week, season, temperature, traffic, etc.). The dwell time module 204 can use the user's calendar information 212 and location trends 224 to determine that the estimated dwell time 206 will be approximately forty-five minutes at 1:00 pm. In some embodiments, the dwell time module 204 can also determine an estimated charge time and/or charging rate for the electric vehicle of the user based on the estimated dwell time 206. For example, a slower charging rate may be used for longer estimated charge times (e.g., two hours), and a faster charging rate may be used for shorter estimated charge times (e.g., fifteen minutes). Accordingly, an electric vehicle is not subjected to unnecessarily fast charging rates, resulting in a prolonged lifespan of the vehicle's battery.

In some embodiments, the estimated dwell time 206 is used to customize media items to display to the users of the electric vehicles. For example, the dwell time module 204 can determine that a first estimated dwell time for a first electric vehicle will be longer than a second estimated dwell time for a second electric vehicle. In some embodiments, an EVCS, server, and/or user device determines that a first media item (e.g., movie ticket sale) may be more desirable to the user of the first electric vehicle because the first media item corresponds to an activity with a time frame similar to the first estimated dwell time. In some embodiments, this determination is made using a database that contains entries where media items correspond to estimated dwell times.

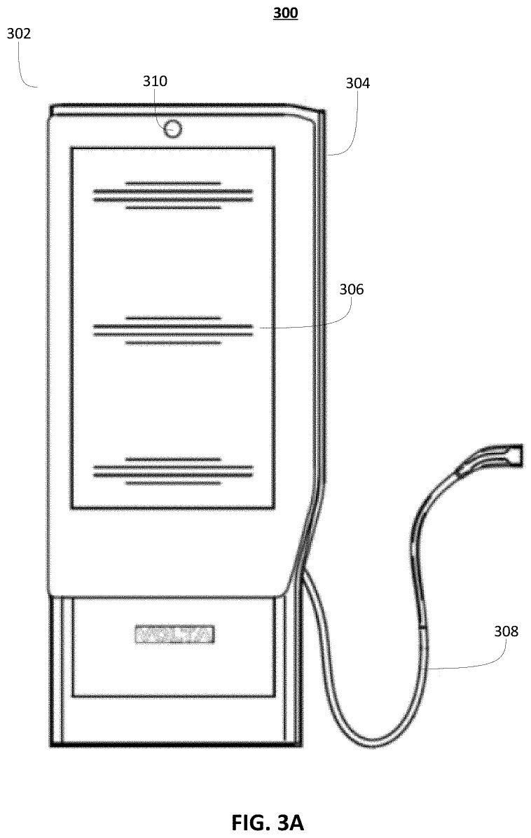

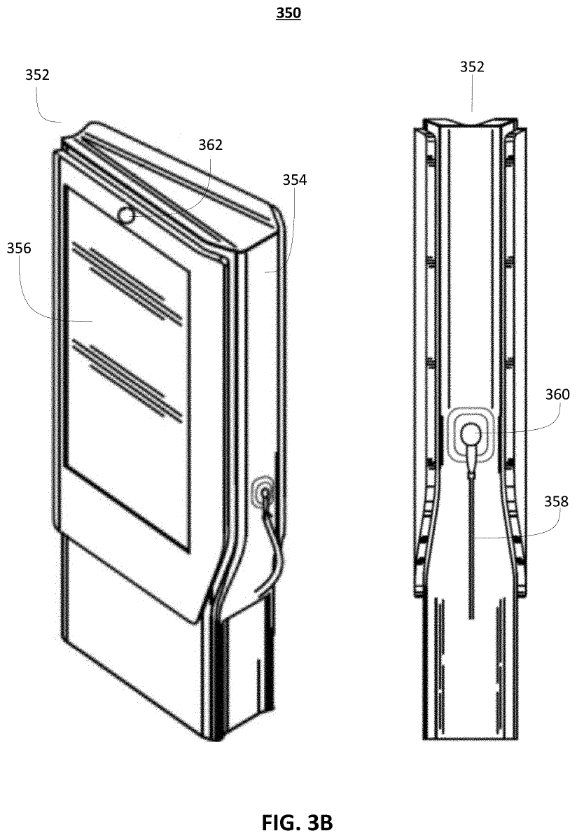

FIG. 3A illustrates an EVCS used for charging an electric vehicle based on the inferred dwell time of the user of the electric vehicle, in accordance with some embodiments of the disclosure. In some embodiments, FIG. 3A illustrates the EVCS displayed in FIG. 1. EVCS 302 includes a housing 304 (e.g., a body or a chassis) that holds a display 306. In some embodiments, EVCS 302 comprises more than one display. For example, EVCS 302 may have a first display 306 and a second display on the other side of EVCS 302. In some embodiments, the display 306 is large compared to the housing 304 (e.g., 60% or more of the height of the frame and 80% or more of the width of the frame), allowing the display 306 to function as a billboard, capable of conveying information to passersby. In some embodiments, the one or more displays 306 display messages (e.g., media items) to users of the EVCS 302 (e.g., operators of the electric vehicle) and/or to passersby that are in proximity to the EVCS 302. In some embodiments, the display 306 has a height that is at least three feet and a width that is at least two feet.

EVCS 302 further comprises a computer that includes one or more processors and memory. In some embodiments, the memory stores instructions for displaying content on the display 306. In some embodiments, the computer is disposed inside the housing 304. In some embodiments, the computer is mounted on a panel that connects (e.g., mounts) a first display (e.g., a display 306) to the housing 304. In some embodiments, the computer includes an NFC system that is configured to interact with a user's device (e.g., user device 108 of a user 106 in FIG. 1).

EVCS 302 further comprises a charging cable 308 (e.g., connector) configured to connect and provide a charge to an electric vehicle (e.g., electric vehicle 104 of FIG. 1). In some embodiments, the charging cable 308 is an IEC 62196 type-2 connector. In some embodiments, the charging cable 308 is a “gun-type” connector (e.g., a charge gun) that, when not in use, sits in a holder (e.g., a holster). In some embodiments, the housing 304 houses circuitry for charging an electric vehicle. For example, in some embodiments, the housing 304 includes power supply circuitry as well as circuitry for determining a state of a vehicle being charged (e.g., whether the vehicle is connected via the connector, whether the vehicle is charging, whether the vehicle is done charging, etc.). In some embodiments, EVCS 302 supports ISO 15118, which allows a user to plug their electric vehicle into EVCS 302 and begin charging without inputting any additional information. ISO 15118 is a communication interface, which, among other things, can identify the make and model of an electric vehicle to an EVCS. When an electric vehicle that supports ISO 15118 begins charging, EVCS 302 can receive vehicle characteristics (e.g., make and model of the electric vehicle) using ISO 15118.

EVCS 302 further comprises one or more cameras 310 configured to capture one or more images of an area proximal to EVCS 302. In some embodiments, the one or more cameras 310 are configured to obtain video of an area proximal to the EVCS 302. For example, a camera may be configured to obtain a video or capture images of an area corresponding to a parking spot associated with EVCS 302. In another example, another camera may be configured to obtain a video or capture images of an area corresponding to a parking spot next to the parking spot of EVCS 302. In some embodiments, the camera 310 may be a wide-angle camera or a 3600 camera that is configured to obtain a video or capture images of a large area proximal to EVCS 302. The one or more cameras 310 may be mounted directly on the housing 304 of EVCS 302 and may have a physical (e.g., electrical, wired) connection to EVCS 302 or a computer system associated with EVCS 302. In some embodiments, the one or more cameras 310 (or other sensors) may be disposed separately from but proximal to the housing 304 of EVCS 302. In some embodiments, the camera 310 may be positioned at different locations on EVCS 302 than what is shown. In some embodiments, the one or more cameras 310 include a plurality of cameras positioned at different locations on EVCS 302.

In some embodiments, EVCS 302 further comprises one or more sensors (not shown). In some embodiments, the one or more sensors detect external objects within a region (area) proximal to EVCS 302. In some embodiments, the area proximal to EVCS 302 includes one or more parking spaces, where an electric vehicle parks in order to use EVCS 302. In some embodiments, the area proximal to EVCS 302 includes walking paths (e.g., sidewalks) next to EVCS 302. In some embodiments, the one or more sensors are configured to determine a state of the area proximal to EVCS 302 (e.g., wherein determining the state includes detecting external objects or the lack thereof). In some embodiments, the external objects can be living or nonliving, such as people, kids, animals, vehicles, shopping carts, toys, etc. In some embodiments, the one or more sensors can detect stationary or moving external objects. In some embodiments, the one or more sensors may be one or more image (e.g., optical) sensors (e.g., one or more cameras 310), ultrasound sensors, depth sensors, IR cameras, RGB cameras, PIR cameras, thermal IR, proximity sensors, radar, tension sensors, NFC sensors, and/or any combination thereof. The one or more sensors may be connected to EVCS 302 or a computer system associated with EVCS 302 via wired or wireless connections such as via a Wi-Fi connection or Bluetooth connection.

In some embodiments, EVCS 302 further comprises one or more lights configured to provide predetermined illumination patterns indicating a status of EVCS 302. In some embodiments, at least one of the one or more lights is configured to illuminate an area proximal to EVCS 302 as a person approaches the area (e.g., a driver returning to a vehicle or a passenger exiting a vehicle that is parked in a parking spot associated with EVCS 302).

FIG. 3B illustrates an EVCS 352 used for charging an electric vehicle based on the inferred dwell time of the user of the electric vehicle, in accordance with some embodiments of the disclosure. In some embodiments, FIG. 3B illustrates the EVCSs displayed in FIGS. 1 and 3A. In some embodiments, FIG. 3B displays additional views of EVCS 302 shown in FIG. 3A. In some embodiments, EVCS 352 comprises housing 354, one or more displays 356, charging cable 358, charging cable holder 360, and one or more cameras 362.

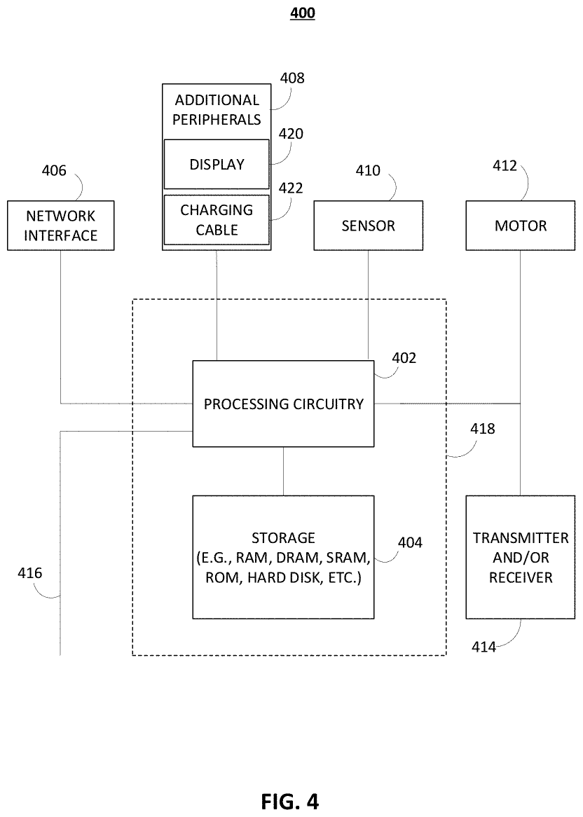

FIG. 4 shows an illustrative block diagram of an EVCS system 400, in accordance with some embodiments of the disclosure. In particular, EVCS system 400 of FIG. 4 may be any of the EVCSs depicted in FIGS. 1, 3A, and/or 3B. In practice, and as recognized by those of ordinary skill in the art, items shown separately could be combined and some items could be separated. In some embodiments, not all shown items must be included in EVCS 400. In some embodiments, EVCS 400 may comprise additional items.

The EVCS system 400 can include processing circuitry 402, which includes one or more processing units (processors or cores), storage 404, one or more networks or other communications network interfaces 406, additional peripherals 408, one or more sensors 410, a motor 412 (configured to retract a portion of a charging cable), one or more wireless transmitters and/or receivers 414, and one or more input/output (I/O) paths 416. I/O paths 416 may use communication buses for interconnecting the described components. I/O paths 416 can include circuitry (sometimes called a chipset) that interconnects and controls communications between system components. EVCS 400 may receive content and data via I/O paths 416. The I/O path 416 may provide data to control circuitry 418, which includes processing circuitry 402 and a storage 404. The control circuitry 418 may be used to send and receive commands, requests, and other suitable data using the I/O path 416. The I/O path 416 may connect the control circuitry 418 (and specifically the processing circuitry 402) to one or more communications paths. I/O functions may be provided by one or more of these communications paths but are shown as a single path in FIG. 4 to avoid overcomplicating the drawing.

The control circuitry 418 may be based on any suitable processing circuitry such as the processing circuitry 402. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The charging of an electric vehicle based on the inferred dwell time functionality can be at least partially implemented using the control circuitry 418. The charging of an electric vehicle based on the inferred dwell time functionality described herein may be implemented in or supported by any suitable software, hardware, or combination thereof. The charging of an electric vehicle based on the inferred dwell time functionality can be implemented on user equipment, on remote servers, or across both.

The control circuitry 418 may include communications circuitry suitable for communicating with one or more servers. The instructions for carrying out the above-mentioned functionality may be stored on the one or more servers. Communications circuitry may include a cable modem, an integrated service digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 404 that is part of the control circuitry 418. As referred to herein, the phrase “storage device” or “memory device” should be understood to mean any device for storing electronic data, computer software, or firmware, such as random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same. In some embodiments, the storage 404 includes one or more storage devices remotely located, such as a database of a server system that is in communication with EVCS 400. In some embodiments, the storage 404, or alternatively the non-volatile memory devices within the storage 404, includes a non-transitory computer-readable storage medium.

In some embodiments, storage 404 or the computer-readable storage medium of the storage 404 stores an operating system, which includes procedures for handling various basic system services and for performing hardware-dependent tasks. In some embodiments, storage 404 or the computer-readable storage medium of the storage 404 stores a communications module, which is used for connecting EVCS 400 to other computers and devices via the one or more communication network interfaces 406 (wired or wireless), such as the Internet, other wide area networks, local area networks, metropolitan area networks, and so on. In some embodiments, storage 404 or the computer-readable storage medium of the storage 404 stores a media item module for selecting and/or displaying media items on the display(s) 420 to be viewed by passersby and users of EVCS 400. In some embodiments, storage 404 or the computer-readable storage medium of the storage 404 stores an EVCS module for charging an electric vehicle (e.g., measuring how much charge has been delivered to an electric vehicle, commencing charging, ceasing charging, etc.), including a motor control module that includes one or more instructions for energizing or forgoing energizing the motor. In some embodiments, storage 404 or a computer-readable storage medium of the storage 404 stores a dwell time module (e.g., dwell time module 204). In some embodiments, executable modules, applications, or sets of procedures may be stored in one or more of the previously mentioned memory devices and correspond to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 404 stores a subset of the modules and data structures identified above. In some embodiments, the storage 404 may store additional modules or data structures not described above.

In some embodiments, EVCS 400 comprises additional peripherals 408 such as displays 420 for displaying content and charging cable 422. In some embodiments, the displays 420 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

In some embodiments, EVCS 400 comprises one or more sensors 410 such as cameras (e.g., camera 116), ultrasound sensors, depth sensors, IR cameras, RGB cameras, PIR cameras, thermal IR, proximity sensors, radar, tension sensors, NFC sensors, and/or any combination thereof. In some embodiments, the one or more sensors 410 are for detecting whether external objects are within a region proximal to EVCS 400, such as living and nonliving objects, and/or the status of EVCS 400 (e.g., available, occupied, etc.) in order to perform an operation, such as determining a vehicle characteristic, user information, region status, etc.

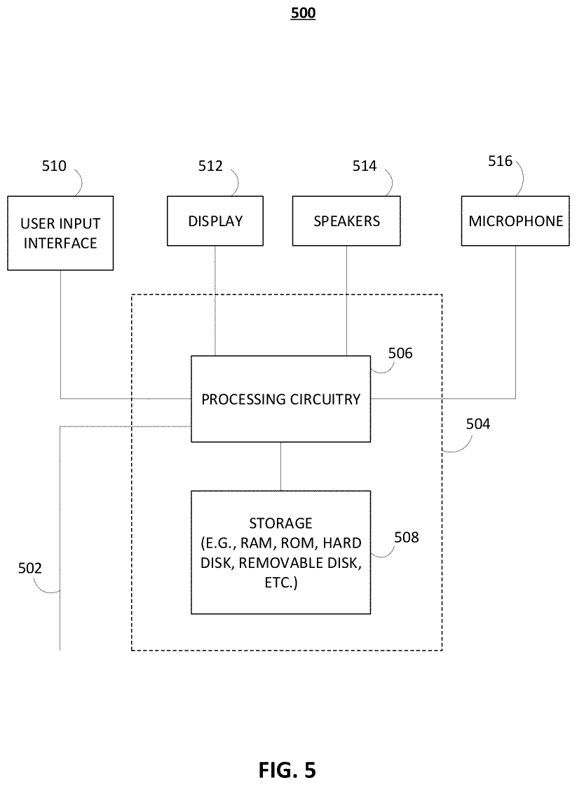

FIG. 5 shows an illustrative block diagram of a user equipment device system, in accordance with some embodiments of the disclosure. In practice, and as recognized by those of ordinary skill in the art, items shown separately could be combined and some items could be separated. In some embodiments, not all shown items must be included in device 500. In some embodiments, device 500 may comprise additional items. In an embodiment, the user equipment device 500 is the same user equipment device displayed in FIGS. 1 and/or 2D. The user equipment device 500 may receive content and data via I/O path 502. The I/O path 502 may provide audio content (e.g., broadcast programming, on-demand programming, Internet content, content available over a local area network (LAN) or wide area network (WAN), and/or other content) and data to control circuitry 504, which includes processing circuitry 506 and a storage 508. The control circuitry 504 may be used to send and receive commands, requests, and other suitable data using the I/O path 502. The I/O path 502 may connect the control circuitry 504 (and specifically the processing circuitry 506) to one or more communications paths. I/O functions may be provided by one or more of these communications paths but are shown as a single path in FIG. 5 to avoid overcomplicating the drawing.

The control circuitry 504 may be based on any suitable processing circuitry such as the processing circuitry 506. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client/server-based embodiments, the control circuitry 504 may include communications circuitry suitable for communicating with one or more servers that may at least implement the described allocation of services functionality. The instructions for carrying out the above-mentioned functionality may be stored on the one or more servers. Communications circuitry may include a cable modem, an integrated service digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 508 that is part of the control circuitry 504. Storage 508 may include random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called a personal video recorder, or PVRs), solid-state devices, quantum storage devices, gaming consoles, gaming media, or any other suitable fixed or removable storage devices, and/or any combination of the same. The storage 508 may be used to store various types of content described herein. Nonvolatile memory may also be used (e.g., to launch a boot-up routine and other instructions). Cloud-based storage may be used to supplement the storage 508 or instead of the storage 508.

The control circuitry 504 may include audio generating-circuitry and tuning circuitry, such as one or more analog tuners, audio-generation circuitry, filters or any other suitable tuning or audio circuits or combinations of such circuits. The control circuitry 504 may also include scaler circuitry for upconverting and down converting content into the preferred output format of the user equipment device 500. The control circuitry 504 may also include digital-to-analog converter circuitry and analog-to-digital converter circuitry for converting between digital and analog signals. The tuning and encoding circuitry may be used by the user equipment device 500 to receive and to display, to play, or to record content. The circuitry described herein, including, for example, the tuning, audio-generating, encoding, decoding, encrypting, decrypting, scaler, and analog/digital circuitry, may be implemented using software running on one or more general purpose or specialized processors. If the storage 508 is provided as a separate device from the user equipment device 500, the tuning and encoding circuitry (including multiple tuners) may be associated with the storage 508.

The user may utter instructions to the control circuitry 504 that are received by the microphone 516. The microphone 516 may be any microphone (or microphones) capable of detecting human speech. The microphone 516 is connected to the processing circuitry 506 to transmit detected voice commands and other speech thereto for processing. In some embodiments, voice assistants (e.g., Siri, Alexa, Google Home, and similar such voice assistants) receive and process the voice commands and other speech.

The user equipment device 500 may optionally include an interface 510. The interface 510 may be any suitable user interface, such as a remote control, mouse, trackball, keypad, keyboard, touch screen, touchpad, stylus input, joystick, or other user input interfaces. A display 512 may be provided as a stand-alone device or integrated with other elements of the user equipment device 500. For example, the display 512 may be a touchscreen or touch-sensitive display. In such circumstances, the interface 510 may be integrated with or combined with the microphone 516. When the interface 510 is configured with a screen, such a screen may be one or more of a monitor, television, liquid crystal display (LCD) for a mobile device, active matrix display, cathode ray tube display, light-emitting diode display, organic light-emitting diode display, quantum dot display, or any other suitable equipment for displaying visual images. In some embodiments, the interface 510 may be HDTV-capable. In some embodiments, the display 512 may be a 3D display. The speaker (or speakers) 514 may be provided as integrated with other elements of user equipment device 500 or may be a stand-alone unit. In some embodiments, the display 512 may be outputted through speaker 514.

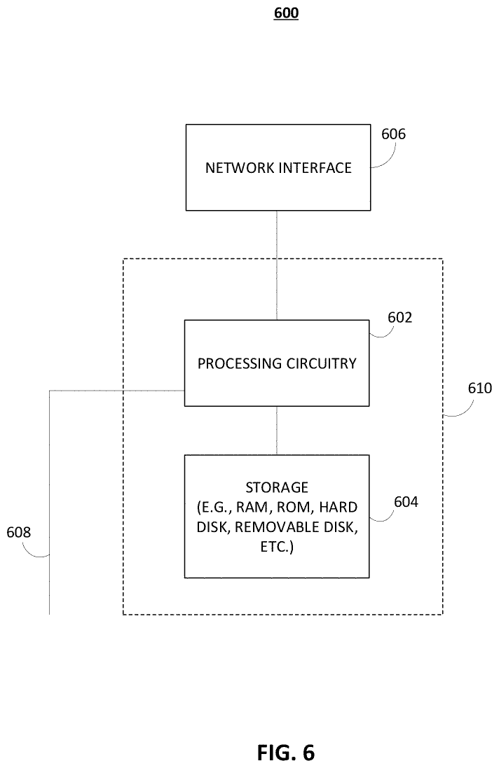

FIG. 6 shows an illustrative block diagram of a server system 600, in accordance with some embodiments of the disclosure. Server system 600 may include one or more computer systems (e.g., computing devices), such as a desktop computer, a laptop computer, and a tablet computer. In some embodiments, the server system 600 is a data server that hosts one or more databases (e.g., databases of images or videos), models, or modules or may provide various executable applications or modules. In practice, and as recognized by those of ordinary skill in the art, items shown separately could be combined and some items could be separated. In some embodiments, not all shown items must be included in server system 600. In some embodiments, server system 600 may comprise additional items.

The server system 600 can include processing circuitry 602 that includes one or more processing units (processors or cores), storage 604, one or more networks or other communications network interfaces 606, and one or more I/O paths 608. I/O paths 608 may use communication buses for interconnecting the described components. I/O paths 608 can include circuitry (sometimes called a chipset) that interconnects and controls communications between system components. Server system 600 may receive content and data via I/O paths 608. The I/O path 608 may provide data to control circuitry 610, which includes processing circuitry 602 and a storage 604. The control circuitry 610 may be used to send and receive commands, requests, and other suitable data using the I/O path 608. The I/O path 608 may connect the control circuitry 610 (and specifically the processing circuitry 602) to one or more communications paths. I/O functions may be provided by one or more of these communications paths but are shown as a single path in FIG. 6 to avoid overcomplicating the drawing.

The control circuitry 610 may be based on any suitable processing circuitry such as the processing circuitry 602. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 604 that is part of the control circuitry 610. Storage 604 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 604 or the computer-readable storage medium of the storage 604 stores an operating system, which includes procedures for handling various basic system services and for performing hardware-dependent tasks. In some embodiments, storage 604 or the computer-readable storage medium of the storage 604 stores a communications module, which is used for connecting the server system 600 to other computers and devices via the one or more communication network interfaces 606 (wired or wireless), such as the Internet, other wide area networks, local area networks, metropolitan area networks, and so on. In some embodiments, storage 604 or the computer-readable storage medium of the storage 604 stores a web browser (or other application capable of displaying web pages), which enables a user to communicate over a network with remote computers or devices. In some embodiments, storage 604 or the computer-readable storage medium of the storage 604 stores a database for storing information on electric vehicle charging stations, their locations, media items displayed at respective electric vehicle charging stations, a number of each type of impression count associated with respective electric vehicle charging stations, user profiles, and so forth.

In some embodiments, executable modules, applications, or sets of procedures may be stored in one or more of the previously mentioned memory devices and correspond to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 604 stores a subset of the modules and data structures identified above. In some embodiments, the storage 604 may store additional modules or data structures not described above.

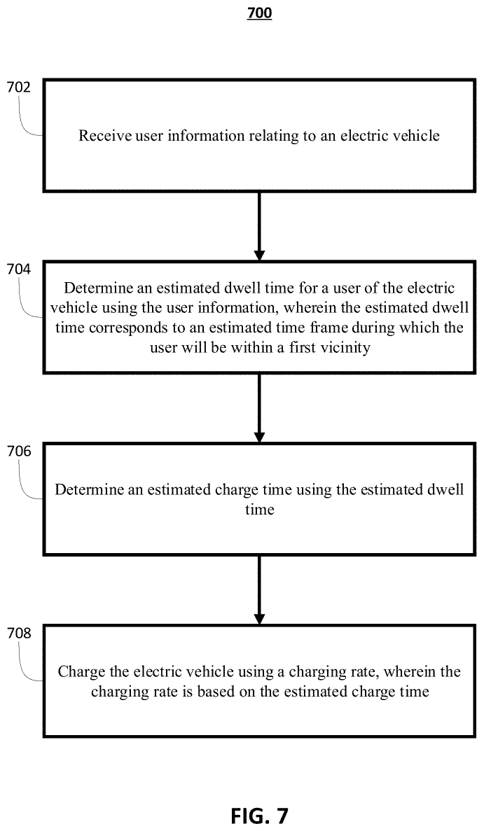

FIG. 7 is an illustrative flowchart of a process 700 for charging an electric vehicle based on the inferred dwell time of the user of the electric vehicle, in accordance with some embodiments of the disclosure. Process 700 may be performed by physical or virtual control circuitry, such as control circuitry 418 of EVCS 400 (FIG. 4). In some embodiments, some steps of process 700 may be performed by one of several devices.

At step 702, control circuitry receives user information (e.g., user location, user calendars, user purchases, user patterns, etc.) relating to an electric vehicle. In some embodiments, the control circuitry receives the user information in conjunction with receiving a request to charge the electric vehicle. In some embodiments, the control circuitry requests the user information from a database and/or server. In some embodiments, the control circuitry requests user information by submitting a request to a database and/or server wherein the request identifies the electric vehicle and/or a user of the electric vehicle. In some embodiments, the control circuitry receives the user information from a database, the user, and or a third-party provider.

At step 704, control circuitry determines an estimated dwell time for the user of the electric vehicle using the user information, wherein the estimated dwell time corresponds to an estimated time frame during which the user will be within a first vicinity. In some embodiments, the first vicinity is within a threshold distance of an EVCS that is charging the electric vehicle. In some embodiments, the control circuitry can use one piece of user information or a plurality of pieces of user information to determine the estimated dwell time. In some embodiments, the control circuitry uses machine learning to determine the estimated dwell time using the received user information. In some embodiments, different user information is weighted according to significance. For example, a first piece of user information indicating that the user has an upcoming event may be weighted more highly than a second piece of user information indicating that the user made a purchase two weeks ago. Accordingly, the control circuitry can use the different weights in determining an estimated dwell time for the user. In some embodiments, control circuitry uses electric vehicle characteristics, location information, and/or similar such information in conjunction with the received user information to determine the estimated dwell time. In some embodiments, the control circuitry notifies the user of the estimated dwell time. In some embodiments, the control circuitry offers the user an option to change the estimated dwell time.

At step 706, control circuitry determines an estimated charge time using the estimated dwell time. In some embodiments, the estimated charge time may be the same or similar to the estimated dwell time. In some embodiments, control circuitry may add or subtract time from the estimated dwell time based on additional factors to determine the estimated charge time. For example, control circuitry may determine that the estimated charge time should be longer than the estimated dwell time to account for a user walking to and from an event. In some embodiments, control circuitry uses user information, electric vehicle characteristics, location information, and/or similar such information in conjunction with estimated dwell time to determine the estimated charge time. In some embodiments, the control circuitry uses machine learning to determine the estimated charge time. In some embodiments, different information is weighted according to significance when determining the estimated charge time. For example, the estimated dwell time may be weighted more highly than user information indicating that the user made a purchase two weeks ago. Accordingly, the control circuitry can use the different weights in determining an estimated charge time for the electric vehicle. In some embodiments, the control circuitry notifies the user of the estimated charge time. In some embodiments, the control circuitry offers the user an option to change the estimated charge time.

At step 708, control circuitry charges the electric vehicle using a charging rate, wherein the charging rate is based on the estimated charge time. In some embodiments, the charging rate changes depending on the time. For example, the charging rate may correspond to a lower amount of voltage per hour in the beginning of a charging period and a higher amount of voltage per hour in the end of a charging period. In some embodiments, control circuitry uses user information, electric vehicle characteristics, location information, and/or similar such information in conjunction with the estimated charge time to determine the charging rate. In some embodiments, the control circuitry uses machine learning to determine the charging rate. In some embodiments, different information is weighted according to significance when determining the estimated charging rate. For example, the estimated charge time may be weighted more highly than user information indicating that the user made a purchase two weeks ago. Accordingly, the control circuitry can use the different weights in determining the charging rate for the electric vehicle. In some embodiments, the control circuitry notifies the user of the charging rate. In some embodiments, the control circuitry offers the user an option to select a different charging rate. In some embodiments, the different charging rates may be more expensive and/or may come with warnings.

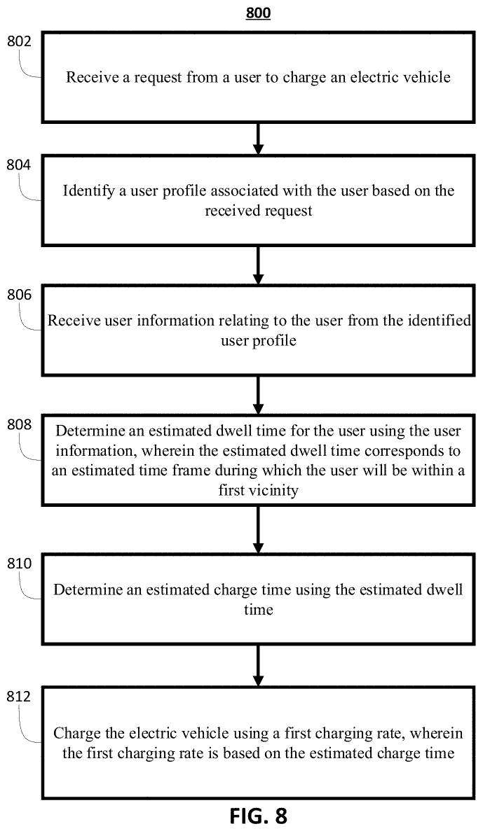

FIG. 8 is another illustrative flowchart of a process 800 for charging an electric vehicle based on the inferred dwell time of the user of the electric vehicle, in accordance with some embodiments of the disclosure. Process 800 may be performed by physical or virtual control circuitry, such as control circuitry 418 of EVCS 400 (FIG. 4). In some embodiments, some steps of process 800 may be performed by one of several devices.

At step 802, control circuitry receives a request from a user to charge an electric vehicle. In some embodiments, the request comprises information that identifies the user. For example, the user may have to input some credentials (e.g., password, pin, biometrics, device, item, etc.) when submitting the request. In some embodiments, the request is communicated to the control circuitry via a network. In some embodiments, the credentials may be automatically inputted. For example, a user device may automatically transmit user credentials to the control circuitry when the user device is within a threshold distance of the control circuitry. In some embodiments, the control circuitry uses characteristics of the electric vehicle as credentials. For example, the control circuitry may automatically obtain characteristics of the electric vehicle using ISO 15118 when the user plugs in their electric vehicle.

At step 804, control circuitry identifies a user profile associated with the user based on the received request. In some embodiments, the control circuitry uses the information contained in the request to identify a user profile associated with the user. For example, the control circuitry may access a database (e.g., located on server 110) that associates the received information (e.g., credentials) with a user profile. In some embodiments, the user profile stores information about the user. For example, the user profile may store user information related to the user, vehicle information of the electric vehicle related to the user, and/or similar such information. In some embodiments, the control circuitry uses one or more sensors to identify vehicle information. In some embodiments, the vehicle information can be used to identify a user profile associated with the user.

At step 806, control circuitry receives user information (e.g., user location, user calendars, user purchases, user patterns, etc.) relating to the electric vehicle from the identified user profile.

At step 808, control circuitry determines an estimated dwell time for the user of the electric vehicle using the user information, wherein the estimated dwell time corresponds to an estimated time frame during which the user will be within a first vicinity. In some embodiments, the first vicinity is within a threshold distance of an EVCS that is charging the electric vehicle. In some embodiments, the control circuitry can use one piece of user information or a plurality of pieces of user information to determine the estimated dwell time. In some embodiments, the control circuitry uses machine learning to determine the estimated dwell time using the received user information. In some embodiments, different user information is weighted according to significance. In some embodiments, control circuitry uses electric vehicle characteristics, location information, and/or similar such information in conjunction with the received user information to determine the estimated dwell time. In some embodiments, the control circuitry notifies the user of the estimated dwell time. In some embodiments, the control circuitry offers the user an option to change the estimated dwell time.

At step 810, control circuitry determines an estimated charge time using the estimated dwell time. In some embodiments, the estimated charge time may be the same or similar to the estimated dwell time. In some embodiments, control circuitry may add or subtract time from the estimated dwell time based on additional factors to determine the estimated charge time. In some embodiments, control circuitry uses user information, electric vehicle characteristics, location information, and/or similar such information in conjunction with estimated dwell time to determine the estimated charge time. In some embodiments, the control circuitry uses machine learning to determine the estimated charge time. In some embodiments, different information is weighted according to significance when determining the estimated charge time. In some embodiments, the control circuitry notifies the user of the estimated charge time. In some embodiments, the control circuitry offers the user an option to change the estimated charge time.

At step 812, control circuitry charges the electric vehicle using a charging rate, wherein the charging rate is based on the estimated charge time. In some embodiments, the charging rate changes depending on the charge time. In some embodiments, control circuitry uses user information, electric vehicle characteristics, location information, and/or similar such information in conjunction with the estimated charge time to determine the charging rate. In some embodiments, the control circuitry uses machine learning to determine the charging rate. In some embodiments, different information is weighted according to significance when determining the estimated charge time. In some embodiments, the control circuitry notifies the user of the charging rate. In some embodiments, the control circuitry offers the user an option to select a different charging rate. In some embodiments, the different charging rates may be more expensive and/or may come with warnings.

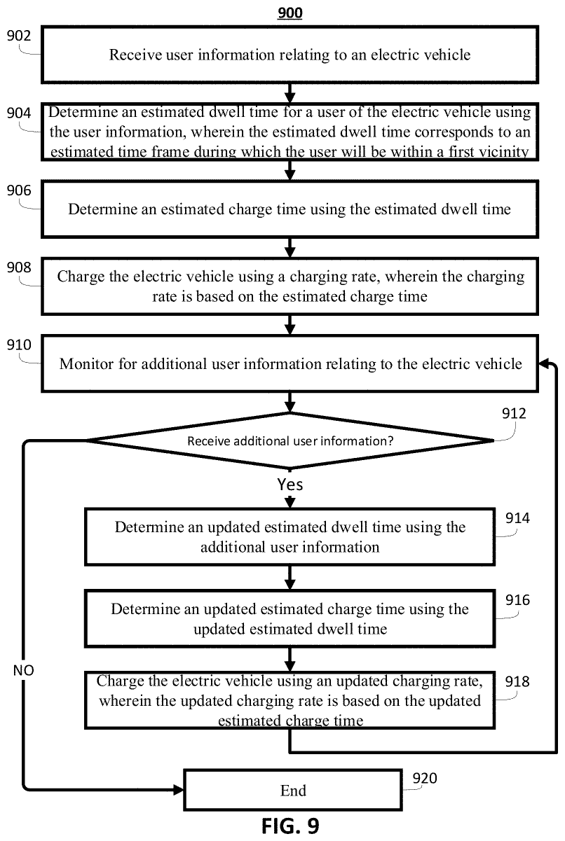

FIG. 9 is an illustrative flowchart of a process 900 for charging an electric vehicle based on the inferred dwell time of the user of the electric vehicle, in accordance with some embodiments of the disclosure. Process 900 may be performed by physical or virtual control circuitry, such as control circuitry 418 of EVCS 400 (FIG. 4). In some embodiments, some steps of process 900 may be performed by one of several devices.

In some embodiments, steps 902-908 may be the same or similar to steps 702-708 described above in FIG. 7.

At step 910, control circuitry monitors for additional user information relating to the electric vehicle. In some embodiments, the additional user information may contain updates to user information used in any of the previous steps. In some embodiments, the additional user information is new user information. In some embodiments, the control circuitry does the monitoring by sending requests for additional user information from a database and/or server. In some embodiments, the control circuitry requests additional user information by submitting requests to a database and/or server wherein the request identifies the electric vehicle and/or a user of the electric vehicle. In some embodiments, the control circuitry monitors for notifications indicating additional user information. In some embodiments, the control circuitry also monitors for additional electric vehicle characteristics, location information, and/or similar such information.

At step 912, control circuitry determines if additional information is received. If no additional information is received as a result of the monitoring, the process continues to the end at step 920. In some embodiments, if no additional information is received, control circuitry continues to charge the electric vehicle using the charging rate described in step 908. In some embodiments, if additional information is received, the process 900 continues to step 914. In some embodiments, the control circuitry also monitors for additional electric vehicle characteristics, location information, and/or similar such information. In some embodiments, the process 900 continues to step 914 if additional electric vehicle characteristics, location information, and/or similar such information is received.

At step 914, control circuitry determines an updated estimated dwell time for the user of the electric vehicle using the additional user information. In some embodiments, the additional user information is used in conjunction with the initial user information and the updated estimated dwell time is determined. In some embodiments, the additional user information replaces the initial user information and the updated estimated dwell time is determined. In some embodiments, the control circuitry uses machine learning to determine the updated estimated dwell time using the additional user information. In some embodiments, the additional user information is weighted and/or causes a reweighting of the initial user information. For example, the additional user information may be weighted more highly than the initial user information. In some embodiments, control circuitry uses electric vehicle characteristics, location information, and/or similar such information in conjunction with the received additional user information to determine the updated estimated dwell time. In some embodiments, additional electric vehicle characteristics, location information, and/or similar such information replaces initial electric vehicle characteristics, location information, and/or similar such information that may have been used in the previous steps. In some embodiments, the control circuitry notifies the user of the updated estimated dwell time. In some embodiments, the control circuitry offers the user an option to change the updated estimated dwell time.

At step 916, control circuitry determines an updated estimated charge time using the updated estimated dwell time. In some embodiments, the updated estimated charge time may be the same or similar to the updated estimated dwell time. In some embodiments, control circuitry may add or subtract time from the updated estimated dwell time based on additional factors to determine the updated estimated charge time. In some embodiments, control circuitry uses initial and/or additional user information, electric vehicle characteristics, location information, and/or similar such information in conjunction with the updated estimated dwell time to determine the updated estimated charge time. In some embodiments, the control circuitry uses machine learning to determine the updated estimated charge time. In some embodiments, different information is weighted according to significance when determining the updated estimated charge time. In some embodiments, the control circuitry notifies the user of the updated estimated charge time. In some embodiments, the control circuitry offers the user an option to change the updated estimated charge time.

At step 918, control circuitry charges the electric vehicle using an updated charging rate, wherein the updated charging rate is based on the updated estimated charge time. In some embodiments, control circuitry uses updated and/or initial user information, electric vehicle characteristics, location information, and/or similar such information in conjunction with the updated estimated charge time to determine the updated charging rate. In some embodiments, the control circuitry uses machine learning to determine the updated charging rate. In some embodiments, different information is weighted according to significance when determining the updated charging rate. In some embodiments, the control circuitry notifies the user of the updated charging rate. In some embodiments, the control circuitry offers the user an option to select a different charging rate. In some embodiments, the different charging rate may be more expensive and/or may come with warnings.

In some embodiments, after step 918, the process 900 continues to step 910, where the control circuitry monitors for more user information. If the control circuitry receives more user information, the control circuitry will perform steps 914-918 again with the received information. In some embodiments, the control circuitry also monitors for more electric vehicle characteristics, location information, and/or similar such information. If no more information is received as a result of the monitoring, the process 900 continues to the end at step 920. In some embodiments, if no more information is received control circuitry continues to charge the electric vehicle using the updated charging rate described in step 918.

It is contemplated that some suitable steps or suitable descriptions of FIGS. 7-9 may be used with other suitable embodiments of this disclosure. In addition, some suitable steps and descriptions described in relation to FIGS. 7-9 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1-6 could be used to perform one or more of the steps in FIGS. 7-9.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving user information relating to an electric vehicle;
determining an estimated dwell time for a user of the electric vehicle using the user information;
determining a charging parameter based on the estimated dwell time.

2. The method of claim 1, wherein the charging parameter is an estimated charge time for the electric vehicle.

3. The method of claim 1, wherein the charging parameter is a charging rate for the electric vehicle.

4. The method of claim 1, wherein the charging parameter is a charging fee for the electric vehicle.

5. The method of claim 1, wherein the charging parameter is a parking fee for the electric vehicle.

6. The method of claim 1, wherein the user information corresponds to the user making a purchase.

7. The method of claim 1, wherein the user information corresponds to a device crossing a first geofence, wherein the device is associated with the user.

8. The method of claim 1, wherein the user information corresponds to a profile associated with a user of the electric vehicle and the profile comprises one or more past estimated charge times.

9. The method of claim 1, further comprising receiving vehicle information relating to the electric vehicle, wherein the estimated dwell time for the user of the electric vehicle is determined using the user information and the vehicle information.

10. The method of claim 9, wherein the vehicle information corresponds to the amount of charge left in a battery of the electric vehicle.

11. The method of claim 9, wherein the vehicle information corresponds to the make and model of the electric vehicle.

12. The method of claim 1, further comprising receiving location information relating to the electric vehicle, wherein the estimated dwell time for the user of the electric vehicle is determined using the user information and the location information.

13. The method of claim 12, wherein the location information comprises the time of day.

14. A method comprising:
receiving, by an electric vehicle charging station, user information relating to an electric vehicle;
determining, by the electric vehicle charging station, an estimated dwell time for a user of the electric vehicle using the user information, wherein the estimated dwell time corresponds to an estimated time frame during which the user will be within a first vicinity; and
determining, by the electric vehicle charging station, a charging parameter based on the estimated dwell time.

15. The method of claim 14, wherein the charging parameter is an estimated charge time for the electric vehicle.

16. The method of claim 14, wherein the charging parameter is a charging rate for the electric vehicle.

17. The method of claim 14, wherein the charging parameter is a charging fee for the electric vehicle.

18. The method of claim 14, wherein the charging parameter is a parking fee for the electric vehicle.

19. The method of claim 14, wherein the user information corresponds to one or more events in a calendar and the calendar is associated with a user of the electric vehicle

20. The method of claim 14, wherein the user information corresponds to a user making a purchase and the user is associated with the electric vehicle.

21-81. (canceled)
